(19) United States
(12) Patent Application Publication
(10) Pub. No.: US 2005/0243459 A1
(43) Pub. Date: Nov. 3, 2005

(54) Disk drive structure having holding portions for protecting a control circuit board

(75) Inventors: Akihiro Kimura, Akishima-shi (JP); Hiroyuki Kuno, Ome-shi (JP)

Correspondence Address: FOLEY & LARDNER, 2029 CENTURY PARK EAST, SUITE 3500, LOS ANGELES, CA, 90067, US

(73) Assignee: KABUSHIKI KAISHA TOSHIBA

(21) Appl. No.: 11/035,286

(22) Filed: Jan. 12, 2005

(30) Foreign Application Priority Data
Apr. 30, 2004 (JP) 2004-136586

(51) Int. Cl. G11B 17/00

(52) U.S. Cl. 360/97.01

(57) ABSTRACT

A disk drive includes a substantially rectangular box-shaped casing having a rectangular mounting surface. In the casing are arranged a disk drive mechanism. A rectangular control circuit board is mounted on the mounting surface of the casing. The control circuit board has four sides aligned with the four sides of the mounting surface, and four corners have recesses to expose the four corners of the mounting surface to permit handling of the disk drive without damaging the control circuit board.

### CROSS-REFERENCE TO RELATED APPLICATIONS

This application is based upon and claims the benefit of priority from prior Japanese Patent Application No. 2004-136586, filed Apr. 30, 2004, the entire contents of which are incorporated herein by reference.

### BACKGROUND OF THE INVENTION

1. Field of the Invention

This invention relates to a disk drive having a disk for use as a recording medium.

2. Description of the Related Art

In recent years, disk drives, such as magnetic disk drives, optical disk drives, etc., have been widely used as external recording devices or image recording devices for computers.

A magnetic disk drive, as a disk drive, generally comprises a rectangular box-shaped casing. The casing houses a magnetic disk, spindle motor, magnetic heads, head actuator, voice coil motor, board unit, etc.

Described in Jpn. Pat. Appln. KOKAI Publication No. 2001-210058 is a magnetic disk drive that has the form of a thin card and can be loaded into a card slot of a personal computer, for example. The card-shaped magnetic disk drive of this type must be made thinner and smaller than a conventional one. To meet this requirement, various components are mounted on a plate-shaped base, a support frame is fixed on the peripheral edge of the base, and a plate-shaped top cover is attached to the support frame. Further, a printed circuit board is located on the backside of the base, and an I/F connector on the circuit board is positioned and held by means of a dedicated fixing member on the support frame.

Miniaturization of magnetic disk drives has recently been promoted so that they can be used as recording units for a wider variety of electronic devices, particularly for compact electronic devices. For example, in a magnetic disk drive with the diameter of a disk larger than 1 inch, a printed circuit board stacked on the outer surface of a casing can be reduced to smaller than the area of the outer surface of the casing. However, in a magnetic disk drive with the diameter of a disk smaller than 1 inch, as a casing is reduced in size, the outer surface of the casing for mounting a printed circuit board is also reduced. Thus, to provide room for the necessary integrated circuits and there interconnections, it is necessary for the printed circuit board to occupy almost the whole area of the outer surface of a casing to which the printed circuit board is secured. In a small magnetic disk drive, the thickness of the whole disk drive must be made thin, and a printed circuit board itself must be made thin and becomes fragile.

When it is necessary to handle the small disk drive or to secure the disk drive casing to an apparatus for use therein, the printed circuit board is likely to be damaged. This is because the printed circuit board overlays substantially the entire outer surface of the casing, and any holding mechanism contacting the casing will necessarily also contact the printed circuit board and will likely cause damage to same. The printed circuit board may thus be peeled or broken at the four corners.

### BRIEF SUMMARY OF THE INVENTION

In accordance with embodiments of the invention, there is provided a disk drive structure comprising a rectangular box-shaped casing having a substantially rectangular shaped mounting surface, the casing housing a disk drive mechanism; and a substantially rectangular shaped control circuit board mounted on the mounting surface of the casing. The control circuit board has four sides substantially aligned with the four sides of the mounting surface, and four corners recessed with respect to the corners of the mounting surface such as to expose the four corners of the mounting surface. The corners of the casing, which include the four exposed corners of the mounting surface, constitute holding portions for holding the casing.

In accordance with other embodiments of the invention, there is provided a disk drive having a rectangular box-shaped casing having a substantially rectangular shaped mounting surface; a disk-shaped recording medium provided in the casing; a drive motor which is arranged in the casing, and supports and rotates the recording medium; a head which processes information for the recording medium; a head actuator which is provided in the casing, and supports the head for movement, and moves the head with respect to the recording medium; and a substantially rectangular shaped control circuit board mounted on the mounting surface of the casing. Four corners of the casing, which include the corners of the mounting surface, are rounded in a shape of arc; and the control circuit board has four sides substantially aligned with the four sides of the mounting surface, and four corners cut obliquely to expose the four corners of the mounting surface.

In accordance with yet other embodiments of the invention, there is disclosed a method of protecting a control circuit board in a disk drive by providing a relatively thin rectangular box-like casing into which mechanical and electrical components of a disk drive are housed, including a recording medium; an outer surface of the casing serving as a mounting surface; providing a control circuit board having substantially the same size and shape as the mounting surface; cutting corners of the control circuit so that when the control circuit board is mounted on the mounting surface, corner portions of the mounting surface are exposed; and mounting the control circuit board on the mounting surface while aligning the control circuit board to substantially overlay the mounting surface.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a hard disk drive (hereinafter referred as an HDD) according to a first embodiment of the invention;

FIG. 2 is an exploded perspective view of the HDD;

FIG. 3 is an exploded perspective view showing a casing and the internal structure of the HDD;

FIG. 4 is a perspective view showing the control circuit board side of the HDD;

FIG. 5 is a sectional view of the HDD taken along line V-V of FIG. 1;

FIG. 6 is a perspective view showing an HDD according to a second embodiment;

FIG. 7 is an exploded perspective view showing the HDD according to the second embodiment;

FIG. 8 is a partially broken side view of the HDD according to the second embodiment;

FIG. 9 is a perspective view showing an HDD according to a third embodiment of the invention; and

FIG. 10 is a perspective view showing an HDD according to a fourth embodiment of the invention.

### DETAILED DESCRIPTION OF THE INVENTION

HDDs according to embodiments of this invention will now be described in detail with reference to the accompanying drawings.

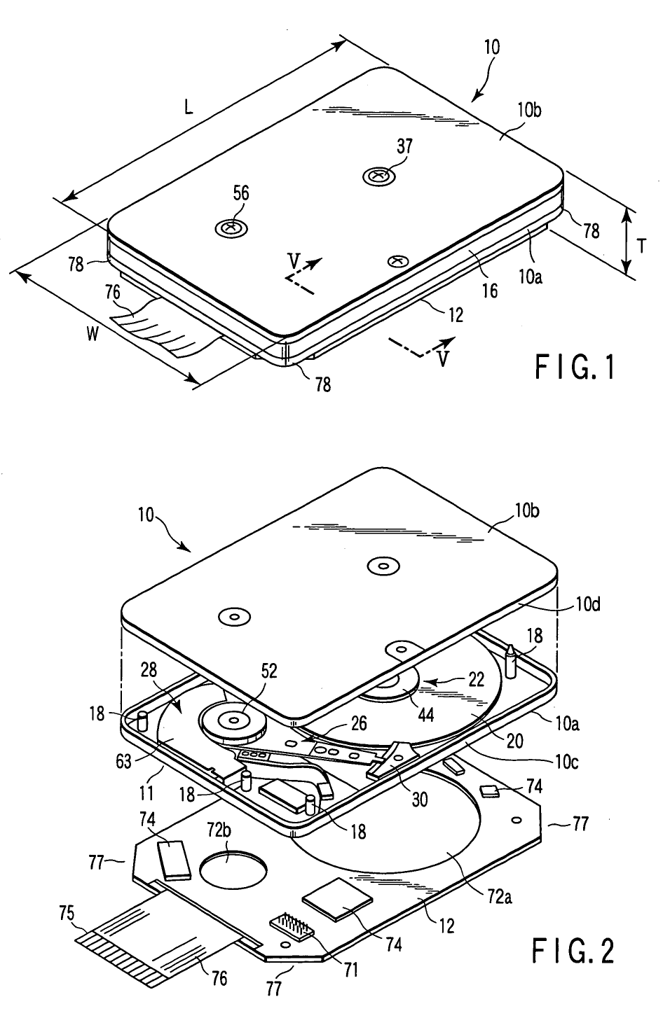

As shown in FIG. 1 and FIG. 2, an HDD comprises a casing 10, and a control circuit board 12. The casing 10 is substantially rectangular box that houses various members, which will be mentioned later. The circuit board 12 is mounted on the outer surface of the casing 10. The casing 10 and control circuit board 12 are formed to be 32 mm long, 24 mm wide, and 5 mm or 3.3 mm thick including the thickness of the casing and circuit board.

As shown in FIGS. 2 and 5, the casing 10 that constitutes the body of an HDD includes first and second shells 10a and 10b, which have substantially equal dimensions. The shells 10a and 10b are substantially rectangular metallic structures having sidewalls on their respective peripheral edge portions. The first and second shells 10a and 10b are arranged to face each other and are opposed to each other with a gap between them defined by the thickness of sidewalls 10c, 10d. A belt-shaped sealing member 16 is wound around the outer surface of the sidewalls 10c, 10d of the shells 10a and 10b so that the sidewalls 10c, 10d are sealed together. The rectangular box casing 10 is configured as above.

The bottom surface of the first shell 10a forms a rectangular mounting surface 11. Four corners of the casing 10 including the ones in the mounting surface 11 are rounded like arcs, thereby preventing the sealing member 16 wound around the peripheral edge portion of the casing 10 from being damaged by the corners of the casing, and preventing deterioration of air-tightness due to slipping of the sealing member.

Support posts 18 are arranged on the peripheral edge portion of the inside of the casing 10. Each post has a proximal end that is fixed to the inner surface of the first shell 10a. It is set substantially perpendicular to the inner surface of the first shell 10a. A screw hole is formed in the mounting surface 11 at the positions of each support post 18, and extended into the support post.

The casing 10 houses a magnetic disk 20, spindle motor 22, magnetic head 24, carriage 26, voice coil motor (hereinafter referred as a VCM) 28, ramp load mechanism 30, electromagnetic latch 32, and board unit 34. The magnetic disk 20 has a diameter of, e.g., 0.85 inches and serves as an information recording medium. The spindle motor 22 serves as a drive motor that supports and rotates the magnetic disk 20. The magnetic head 24 writes information in and reads it from the disk 20. The carriage 26 supports the magnetic head 24 for movement with respect to the magnetic disk 20. The VCM 28 rotates and positions the carriage 26. The ramp load mechanism 30 unloads the magnetic head 24 to a position at a distance from the magnetic disk 20 when the head is moved to the peripheral portion of the disk 20. The electromagnetic latch 32 holds the carriage 26 in a retreated position. The board unit 34 has a head IC and the like.

The spindle motor 22 is mounted on the first shell 10a. The motor 22 has a spindle 36, which is fixed to and set substantially perpendicular to the inner surface of the first shell 10a. An extended end of the spindle 36 is fixed to the second shell 10b with a fixing screw 37 that is screwed into the second shell from outside. Thus, the spindle 36 is supported by the first and second shells 10a and 10b from both sides.

A bearing (not shown) rotatably supports a rotor on the spindle 36. A second-shell-side end portion of the rotor constitutes a columnar hub 43. The magnetic disk 20 is coaxially fitted on the hub 43. A clamp ring 44 is fitted on an end portion of the hub 43, thereby holding the inner peripheral edge portion of the disk 20. Thus, the disk 20 is fixed to the rotor so that it can rotate integrally with the rotor.

A ring-shaped permanent magnet (not shown) is fixed to a first-shell-side end portion of the rotor so that it is coaxial with the rotor. The spindle motor 22 has a stator core attached to the first shell 10a and coils wound around the stator core. The stator core and the coils are located outside the permanent magnet with a gap between them.

The carriage 26 which constitutes a head actuator is provided with a bearing assembly 52 that is fixed on the inner surface of the first shell 10a. The bearing assembly 52 has a pivot 53 and a cylindrical hub 54. The pivot 53 is set up on the inner surface of the first shell 10a at right angles thereto. The hub 54 is rotatably supported on the pivot 53 by means of a pair of bearings. An extended end of the pivot 53 is fixed to the second shell 10b with a fixing screw 56 that is screwed into the second shell from outside. Thus, the pivot 53 is supported by the first and second shells 10a and 10b from both sides.

The carriage 26 is provided with an arm 58, a suspension 60, and a support frame 62. The arm 58 extends from the hub 54, and the suspension 60, in the form of an elongated plate, extends from the distal end of the arm. The frame 62 extends from the hub 54 in a direction opposite to the extension of the arm 58. A gimbals portion (not shown) supports the magnetic head 24 on an extended end of the suspension 60. The magnetic head 24 is supplied with predetermined head load toward the surface of the magnetic disk 20 by the spring force of the suspension 60. A voice coil 64 that constitutes the VCM 28 is fixed integrally to the frame 62.

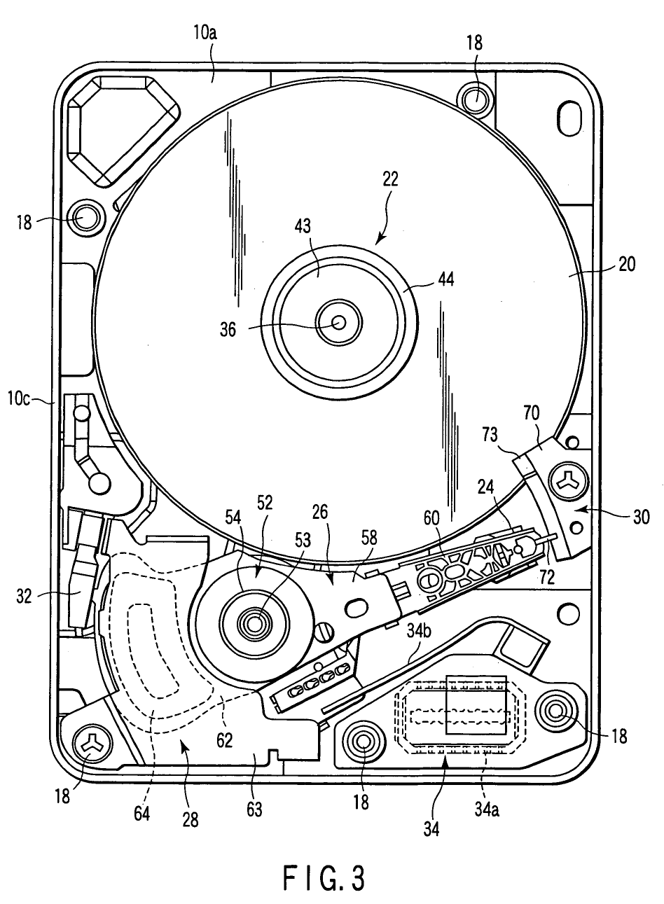

The VCM 28, which rotates the carriage 26 around the bearing assembly 52, includes a pair of yokes 63, a magnet (not shown). The yokes 63 are fixed on the first shell 10a opposite to each other with a gap between them. A magnet is fixed to the inner surface of one of the yokes 63 and opposed to the voice coil. When the voice coil 64 is energized, the carriage 26 rotates over the magnetic disk 20 between the retreated position indicated in FIG. 3 and the outer periphery of the disk. Thereupon, the magnetic head 24 is positioned on a desired track of the magnetic disk 20. If the HDD is subjected to external force such as shock, the electromagnetic latch 32 that is fixed to the first shell 10a latches the carriage 26 in the retreated position, thereby preventing the carriage from moving from the retreated position to an operating position.

The ramp load mechanism 30 comprises a ramp member 70 and a tab 72. The ramp member 70 is fixed to the inner surface of the first shell 10a and opposed to the peripheral edge portion of the magnetic disk 20. The tab 72 extends from the distal end of the suspension 60 and serves as an engaging member. The ramp member 70 is formed by bending a plate member and has a ramp surface 73 that can be engaged by the tab 72. When the carriage 26 rotates from the inner peripheral portion of the magnetic disk 20 to the retreated position on the outer periphery of the magnetic disk, the tab 72 engages the ramp surface 73 of the ramp member 70. Thereafter, the tab 72 is pulled up by the inclination of the ramp surface, whereupon the magnetic head 24 is unloaded. When the carriage 26 rotates to the retreated position, the tab 72 is supported on the ramp surface 73 of the ramp member 70, and the head 24 is kept apart from the surface of the disk 20.

The board unit 34 has a body 34a that is formed of a flexible printed circuit board. The body 34a is fixed to the inner surface of the first shell 10a. The head IC, a head amplifier, and other electronic components are mounted on the body 34a. The board unit 34 has a main flexible printed circuit board (hereinafter referred as a main FPC) 34b that extends from the body 34a. An extended end of the main FPC 34b is connected to the part of the carriage 26 which is situated near the bearing assembly 52, and is also connected electrically to the magnetic head 24 through a cable (not shown) on the arm 58 and the suspension 60. A connector (not shown) to be connected to the control circuit board 12 is mounted on the bottom surface of the body of the board unit 34. The connector is exposed to the mounting surface 11 of the first shell through an opening in the first shell 10a.

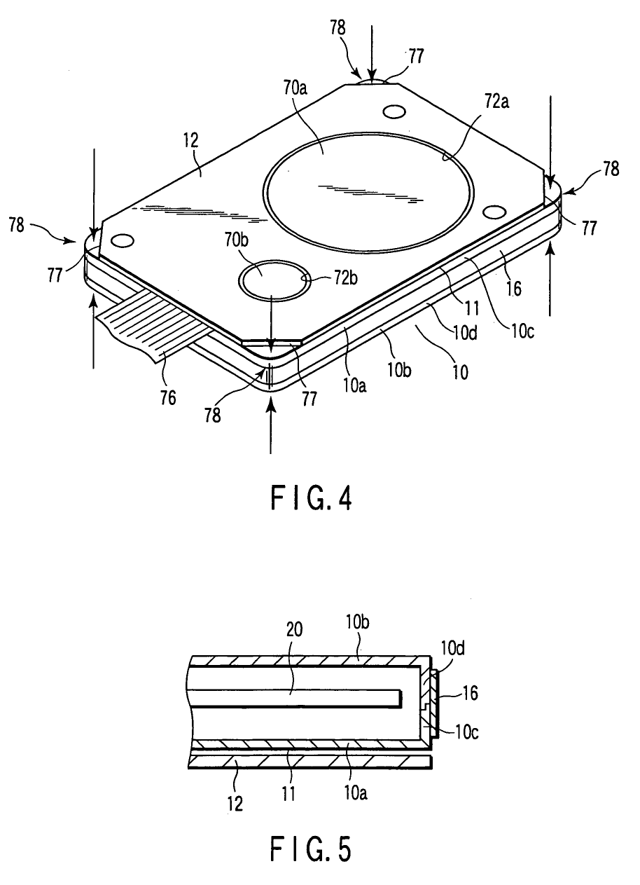

As shown in FIGS. 2, 4 and 5, the control circuit board 12 formed of a printed circuit board has substantially the same plane shape as the mounting surface 11 of the casing 10. Circular projections 70a and 70b are formed on the mounting surface 11 of the casing 10. The projection 70a corresponds to the spindle motor 22, and the projection 70b corresponds to the bearing assembly 52. The control circuit board 12 is provided with circular openings 72a and 72b, which correspond to the projections 70a and 70b, respectively. Electronic components 74 and connectors 71 are mounted on the control circuit board 12. A flexible printed circuit board 76 is also connected to the circuit board 12 for electrically connecting the HDD to an external device. The flexible printed circuit board 76 extends outward from one short side of the control circuit board 12, and connection terminals 75 are formed at the extended end. Four corners of the control circuit board 12 are obliquely cut with an angle of 45° with respect to each side, defining notches 77. The notches 77 may be considered recessed on the control circuit board. Alternatively, other types of recesses may be used such as arcs, or triangular cuts or partial holes. In general a recess will expose a portion of the underlying mounting surface which may then be used to handle or mount the casing.

The control circuit board 12 constructed in this manner is stacked on the mounting surface 11 of the casing 10, and screwed to the first shell 10a with screws. The control circuit board 12 is arranged in the state that the four sides thereof are aligned with, or coincide with the four sides of the mounting surface 11, respectively. The projections 70a and 70b formed through the mounting surface 11 are arranged in the openings 72a and 72b of the control circuit board 12. The connector 71 mounted on the control circuit board 12 is connected to the connector of the board unit 34.

The notches 77 formed at the four corners of the control circuit board 12 are positioned at the four corners of the mounting surface 11. Thus, the four corners of the mounting surface 11 are exposed to outside without being covered by the control circuit board 12. The corners of the casing 10 including the exposed four corners of the mounting surface 11 constitute holding portions 78 for holding the casing without contacting the control circuit board 12.

According to the HDD constructed in this manner, the corners of the casing 10 including the corners of the mounting surface 11 are formed like arcs. The four corners of the control circuit board 12 mounted on the mounting surface 11 are provided with recesses such as, for example, by cutting the control circuit board obliquely to form notches 77. The corners of the casing 10 including the four exposed corners on the mounting surface 11 constitute the holding portions 78 for holding the casing. Thus, when mounting the HDD in another electronic device, for example, it is possible to mount the HDD with being held at the four holding portions 78 of the casing 10 without contacting the control circuit board 12. Therefore, even if the control circuit board 12 is made thin and stacked on the entire area of the mounting surface 11 except the corners, application of mechanical load to the control circuit board can be prevented, and the HDD can be stably held without peeling off or breaking the control circuit board.

The first and second shells 10a and 10b that constitute the casing 10 are supported opposite each other with the given gap between them by the support posts 18 on one of them. If any external force acts on the casing 10, therefore, it can be prevented from damaging the casing 10 and the components therein. With use of the support posts 18, moreover, screwing positions between the first and second shells 10a and 10b can be reduced in number, and assembly and maintenance can be improved.

The card-shaped, portable HDD constructed in this manner can be used as a recording device for various electronic devices, such as, cellular phones, digital cameras, video cameras, personal digital assistants (PDA).

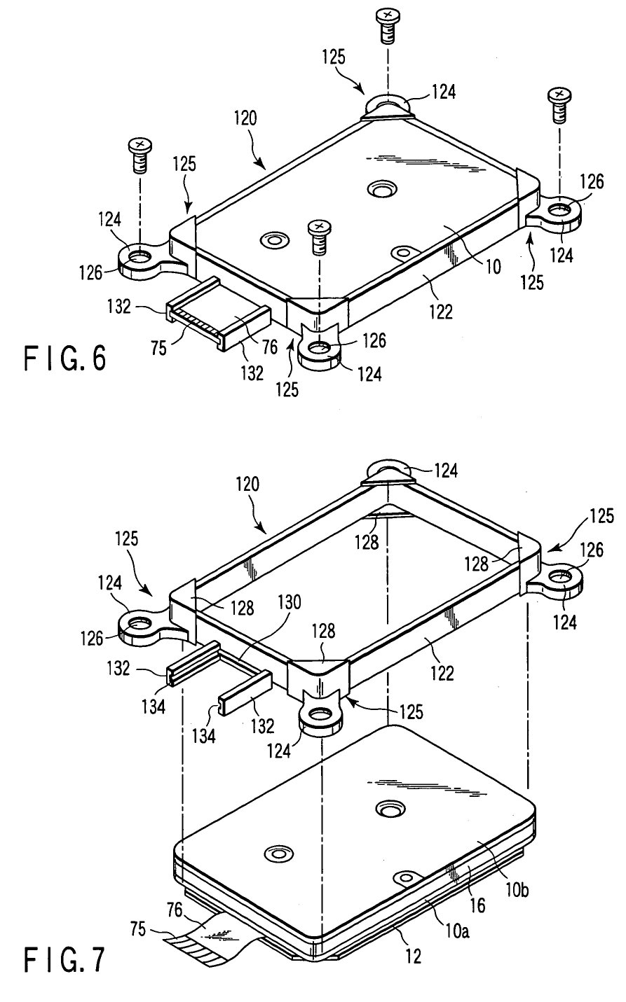

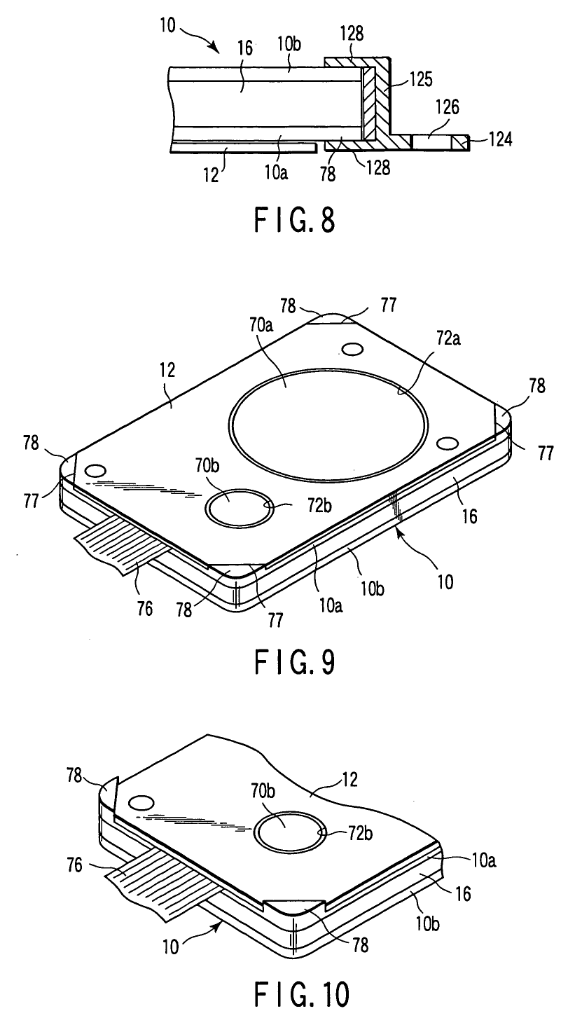

As in a second embodiment shown in FIGS. 6-8, when the HDD is configured as a built-in type HDD to be built in an electronic device, the HDD may be provided with a mounting aid 120 that supports its mounting on the electronic device. The mounting aid 120 has a body 122 and four brackets 125. The body 122 is a rectangular frame that is fitted on outer peripheral portions of the casing 10. The rectangular frame is somewhat flexible and may be bent to fit over the casing 10. The brackets 125 are fixed to the corner portions of the body 122. The body 122 is formed of an elastic material such as synthetic resign and is elastically fitted on the peripheral end portions of the casing 10.

Each bracket 125 is formed of rubber or synthetic resign, for example. Each bracket 125 is fitted on each corner of the body 122 from outside, and has a pair of engaging portions 128 and a leg portion 124. The engaging portions 128 protrude to the inside of the body 122 from the upper and lower corners of the body. The engaging portions 128 are opposed to each other with a given gap. The engaging portions 128 engage with the casing 10 contacting the holding portions 78 of the casing from the upper and lower directions. In this case, the engaging portions 128 engage with the casing 10 without contacting the control circuit board 12. The leg portion 124 extends outward from the corner of the body 122. A through hole 126 is formed in each leg portion 124. A screw for attaching the HDD to a mounting portion of an electronic device can pass through the through hole 126.

A slit 130 is formed in one sidewall of the body 122. A pair of retaining lugs 132 extend integrally outward from the opposite sides of the slits, and serve as cable support portions. The retaining lugs 132 that serve as cable supporting members extend parallel to each other, and their opposite surfaces are each formed having support grooves 134 that extend to the slit 130. The flexible printed circuit board 76 that constitutes a connecting cable is led out from the control circuit board 12 through the slit 130 of the body 122. The opposite side edge portions of the circuit board 76 engage with the supporting grooves 134 of the retaining lugs 132. Thus, the extended end portion of the flexible printed circuit board 76 is held by the retaining lugs 132 in a given position.

The HDD, having the mounting aid 120 fitted thereon in this manner, can be easily mounted in a desired position in the electronic device. At the same time, the extended end portion of the flexible printed circuit board 76, on which the connection terminals are provided, is held in the given position by the retaining lugs 132, so that it can be connected electrically to the electronic device with ease and reliability. The mounting aid 120 is engaged with the peripheral edge portions of the casing 10 and the holding portions 78 without contacting the control circuit board 12. This prevents application of mechanical load to the control circuit board 12 and enables holding of the HDD stably without peeling off and breaking the control circuit board.

As shown in FIG. 9, in a HDD according to a third embodiment of the invention, on the mounting surface 11 of the casing 10, the four corners opposed to the notches 77 of the control circuit board 12 are formed to have protrusions to protrude from the other areas on the mounting surface, and the top surface of these protrusions are positioned on the same plane as the control circuit board 12, i.e., when assembled, these protrusions are level with the exposed surface of the control board 12.

As shown in FIG. 10, in a HDD according to a fourth embodiment of the invention, on the mounting surface 11 of the casing 10, the four corners opposed to the notches 77 of the control circuit board 12 are formed with protrusions which protrude from the other areas on the mounting surface. These protrusions have a top surface which extends above the exposed surface of the control circuit board.

In the third and fourth embodiments, the corners of the casing 10 including the four exposed corners of the mounting surface 11 constitute the holding portions 78 for holding the casing. Thus, when the HDD is mounted in another electronic device, the HDD can be mounted in the state being held by the four holding portions 78 of the casing 10 without contacting the control circuit board 12. Therefore, even if the control circuit board 12 is formed thin and stacked on the whole area of the mounting surface 11 except the corners, application of mechanical load to the control circuit board can be prevented, and the HDD can be stably held without the control circuit board peeling off and breaking. The third and fourth embodiments share the other configurations with the first embodiment, so that like reference numerals are used to designate like portions, and a detailed description of those portions will be omitted.

It is to be understood that the present invention is not limited to the precise embodiments described above, and that various changes and modifications may be effected therein without departing from the scope or spirit of the invention. Further, various other inventions may be made by suitably combining the components described in connection with the foregoing embodiments. For example, some of the components according to the embodiments may be omitted. Further, the components according to different embodiments may be suitably combined as required.

For example, the number of magnetic disks used in the disk drive is not limited to one but may be increased as required. A magnetic disk is not limited to 0.85 inches. Disks of other sizes, such as, for example, 1.8 or 2.5 inches may be used. A control circuit board may be provided with a connector for connecting an external device, instead of a connection cable.

1. A disk drive structure comprising:
a rectangular box-shaped casing having a substantially rectangular shaped mounting surface, said casing housing a disk drive mechanism; and
a substantially rectangular shaped control circuit board mounted on the mounting surface of the casing;
the control circuit board having four sides substantially aligned with the four sides of the mounting surface, and four corners recessed with respect to the corners of the mounting surface such as to expose the four corners of the mounting surface; and
the corners of the casing, which include the four exposed corners of the mounting surface, constituting holding portions for holding the casing.

2. The disk drive structure according to claim 1, wherein the four exposed corners of the mounting surface form protrusions which protrude from the other areas of the mounting surface, said protrusions having a top surface positioned in the same plane as the control circuit board.

3. The disk drive structure according to claim 1, wherein the four exposed corners of the mounting surface form protrusions which protrude from the other areas of the mounting surface and extent above the outer surface of the control circuit board.

4. The disk drive structure according to claim 1, wherein
the casing has a first shell, and a second shell which is provided opposite to the first shell and constitutes the casing with the first shell, the first and second shells having peripheral sidewall portions opposed to each other; and
the casing has a sealing member which is wound around the sidewall portions of the first and second shells for securing the peripheral edge portions to each other, and sealing a gap between the first and second shells.

5. The disk drive according to claim 4, wherein the casing has four rounded corners defined of said sidewalls, said rounded corners including the corners of the mounting surface.

6. The disk drive structure according to claim 1, wherein said disk drive mechanism includes:
a disk-shaped recording medium provided in the casing;
a drive motor which is arranged in the casing, and supports and rotates the recording medium;
a head which processes information for the recording medium; and
a head actuator which is provided in the casing, and supports the head for movement, and moves the head with respect to the recording medium.

7. The disk drive structure according to claim 1, wherein said recessed corners of said control circuit board have a straight oblique edge joining adjacent sides of said control circuit board.

8. The disk drive structure as recited in claim 1, wherein said control circuit board is flexible.

9. The disk drive structure according to claim 1, further comprising a mounting aid which is fitted to the casing, the mounting aid including:
a frame-shaped body fitted to the peripheral portion of the casing,
engaging portions which are provided at four corners of the body and engage with the holding portions of the casing including the exposed corners of the mounting surface, and
a plurality of leg portions extending outward from the body and each having a through hole through which a fixing screw can be passed.

10. The disk drive structure according to claim 9, further comprising a connection cable which extends from the control circuit board and has a connection terminal, and wherein the mounting aid has a cable supporting portion which supports the connection cable with the connection terminal exposed.

11. The disk drive structure according to claim 1, wherein the casing and control circuit board are formed to be about 32 mm long, about 24 mm wide, and about 3.3 mm thick including the thickness of the casing and circuit board.

12. The disk drive structure according to claim 6, wherein the recording medium has a diameter of 0.85 inches.

13. The disk drive structure according to claim 12, wherein the casing and control circuit board are formed to be about 32 mm long, about 24 mm wide, and about 3.3 mm thick including the thickness of the casing and circuit board.

14. A disk drive comprising:
a rectangular box-shaped casing having a substantially rectangular shaped mounting surface;
a disk-shaped recording medium provided in the casing;
a drive motor which is arranged in the casing, and supports and rotates the recording medium;
a head which processes information for the recording medium;
a head actuator which is provided in the casing, and supports the head for movement, and moves the head with respect to the recording medium; and
a substantially rectangular shaped control circuit board mounted on the mounting surface of the casing;
four corners of the casing, which include the corners of the mounting surface, being rounded in a shape of arc; and
the control circuit board having four sides substantially aligned with the four sides of the mounting surface, and four corners cut obliquely to expose the four corners of the mounting surface.

15. A method of protecting a control circuit board in a disk drive comprising:
providing a relatively thin rectangular box-like casing into which mechanical and electrical components of a disk drive are housed, including a recording medium; an outer surface of said casing serving as a mounting surface;
providing a control circuit board having substantially the same size and shape as the mounting surface;
cutting corners of said control circuit so that when said control circuit board is mounted on said mounting surface, corner portions of said mounting surface are exposed; and
mounting the control circuit board on said mounting surface while aligning said control circuit board to substantially overlay said mounting surface.
